(19) United States
(12) Patent Application Publication
(10) Pub. No.: US 2002/0120872 A1
(43) Pub. Date: Aug. 29, 2002

(54) Internet roaming method

(76) Inventors: Takeshi Amada, Yokohama (JP); Yuko Yonekura, Yokohama (JP); Etsuko Iwama, Yokohama (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/907,930

(22) Filed: Jul. 19, 2001

(30) Foreign Application Priority Data
Feb. 27, 2001 (JP) 2001-051722

(51) Int. Cl. G06F 11/30

(52) U.S. Cl. 713/201

(57) ABSTRACT

In an Internet roaming service, an amount of user information transferred between an authentication server of an uncontracted company which a user does not have a contract with and an authentication server of a contracted company which the user has a contract with is reduced, thereby a load applied on a backbone is reduced. When a user makes connection to the uncontracted company, the authentication server of the uncontracted company registers the user information of the user with a user information table out of the user information received from the user and the information contained in an authentication response received from the contracted company. When the user makes a connection request again to the access server of the uncontracted company, the authentication server of the uncontracted company performs authentication for the uncontracted user by using the information registered with the user information table of its own server. Thus, roaming connection is provided without making any queries to the authentication server of the contracted company.

### BACKGROUND OF THE INVENTION

1. Field of the Invention

The invention relates to a provider roaming method for an Internet dialup connection. More particularly, the present invention relates to an Internet provider roaming service and a roaming method, capable of reducing a load on backbone by reducing the amount of information transferred between a roaming original authentication server and a roaming destination authentication server.

2. Description of the Related Art

To meet the request of a mobile equipment user, a provider who offers the Internet dialup connections must locate access points all around the world. However, it is difficult to locate access points in all the regions. In order to enable this, an Internet roaming method is available. At present, there are iPass, GRIC, and the like, as organizations to provide the Internet roaming services. The provider contracts with one of such organizations to provide the Internet roaming. One of connection methods by roaming in such a case has been that when a dialup user dials up to an access point of a provider which the user has no contract with, a query is sent to a server owned by an organization, regarding an authentication server of a provider which the user has a contract with, and thus the user information is transferred between an roaming destination provider authentication server dialed up by the dialup user and an authentication server of the contracted provider. The other method has been that a server of an organization such as iPass, is interposed between the roaming destination provider authentication server and the authentication server of the contracted provider an intermediator for the transfer of the user information.

Another example has been that instead of making a contract with such an organization, providers affiliate with each other, and each provider opens access points to users contracted with an affiliated provider, thereby expanding access point regions to the users contracted with each provider. In this case, with regard to dialup connection by roaming, when the dialup user dialed up the access point of the provider which the user does not have a contract with, authentication and accounting requests were made through the backbone from a proxy server of an uncontracted provider dialed up by an uncontracted user to an authentication server of a contracted provider which the user has a contract with, thereby realizing a dialup connection.

In the conventional provider roaming service, only the contracted provider had the information of the dialup user. Thus, each time an access point of the uncontracted provider was dialed up, it was necessary for the authentication server of the provider which the dialup user does not have a contract with, to make an authentication request through the backbone to the authentication server of the provided contracted by the dialup user. Consequently, the user information was always communicated on the backbone, which may cause an authentication failure due to a packet hiatus, or a load on the backbone. In addition, despite security such as encryption was provided, the security has been deemed unsafe compared with authentication processing in a local network with assured security, because the user information has been communicated on the Internet.

Furthermore, at each provider, a contracted user and a roaming user have not been distinguished. Consequently, there has been a concern of a shortage of lines at an access point in the event that the number of roaming connections was increased, resulting in connection disabilities with the contracted users of the provider.

A first object of the present invention is to provide the Internet roaming capable of solving the problems such as an authentication failure due to a packet loss, a load on the backbone and the like, by relatively reducing the amount of user information communicated on the backbone, and also assuring security by performing authentication of a roaming user within a local network.

A second object of the present invention is to solve a decline in the quality of service for the contracted users, such as connection disabilities or the like caused by an increase of roaming connections, by establishing priorities between the contracted users and the roaming users.

Another object of the present invention is as follows. Especially when an uncontracted user makes connection to an uncontracted company, the authentication server of the uncontracted company registers the user information of the uncontracted user with its own user information table out of the information received from the uncontracted user and the information contained in an authentication response received from the authentication server of a contracted company of the user. Thus, for the connection of the uncontracted user from a second time and after, the uncontracted user can be connected without querying the authentication server of the contracted company about the user information. Therefore, according to the invention, it is possible to reduce the transfer of user information between the uncontracted company and the contracted company, a load placed on the backbone, and authentication failures caused by packet losses, as well as to assure security by user authentication only within the local network.

In addition, according to the present invention, the authentication server of the uncontracted company rejects the connection by the uncontracted user when a line occupancy rate of its own network is high. Thus, it is possible to prevent a service decline for its own users, caused by providing a roaming service.

Furthermore, according to the present invention, information regarding the balance in an accounting service of a prepaid system is transferred between the authentication server of the uncontracted company and the authentication server of the contracted company. Thus, it is possible to apply an accounting service of a prepaid system to the Internet roaming.

### SUMMARY OF THE INVENTION

The above-described first object of the invention is achieved in a manner that, especially when a user dials up to an access server owned by an uncontracted company which the user does not have a contact with, the authentication server of the uncontracted company transmits an authentication request of the user to an authentication server of a contracted company which the user has a contract with. Thereafter, the authentication server of the contracted company returns a response regarding the authentication request, then the authentication server of the uncontracted company that received the response registers the user information of the uncontracted user with a user information table out of the user information received from the user and the information contained in the authentication response received from the authentication server of the contracted company. Moreover, the object is achieved in a manner that, when the user makes a connection request to the access server of the uncontracted company again, the authentication server of the uncontracted company performs authentication for the uncontracted user by using the information registered with the user information table in its own server, and thereby providing a roaming connection without querying to the authentication server of the contracted company.

The above-described second object of the present invention is achieved in a manner that, especially when a user makes a connection request to the access server of the uncontracted company, if the line occupancy rate of the uncontracted company is high, the connection of the uncontracted user is rejected whereby giving priority to the connection of a user having a contract with the uncontracted company. Moreover, the object is achieved in a manner that, a priority is given for each user, and the connection of an uncontracted user having a high priority is permitted even if the line occupancy rate of the uncontracted company is high.

In accordance with a first aspect of the present invention, provided is an Internet roaming method at a communication device of a provider having a plurality of access servers and an authentication server for communicating with the access servers for providing the Internet dialup connection services. Here, the Internet roaming method comprises the steps of; enabling, between a communication device of the contracted company which a user has a contract with and a communication device of an uncontracted company which the user does not have a contract with, the user to make connection to the access server of the uncontracted company, by querying about information of the user to the authentication server of the contracted company by the authentication server of the uncontracted company when the user makes connection to an access server in the communication device of the uncontracted company; transmitting an authentication request of the user from the authentication server of the uncontracted company to the authentication server of the contracted company which the user has a contract with; returning a response regarding the authentication request by the authentication server of the contracted company; and registering, by the authentication server of the uncontracted company that received the response, user information of the uncontracted user in a user information table out of the user information received from the user and the information contained in the authentication response received from the authentication server of the uncontracted company.

In accordance with a second aspect of the present invention, provided is an Internet roaming method at a communication device of a provider having a plurality of access servers and an authentication server for communicating with the access servers for providing the Internet dialup connection services. Here, the Internet roaming method comprises the steps of: enabling, between a communication device of the contracted company which a user has a contract with and a communication device of an uncontracted company which the user does not have a contract with, the user to make connection to the access server of the uncontracted company, by querying about information of the user to the authentication server of the contracted company by the authentication server of the uncontracted company when the user makes connection to an access server in the communication device of the uncontracted company; identifying whether the user is a contracted user or an uncontracted user by a domain name or a user name by the authentication server of the uncontracted company; and rejecting, by the server of the uncontracted company, connection by the uncontracted user to give priority to other users having contracts with the uncontracted company where the server of the uncontracted company identifies that the user is an uncontracted user and where a line occupancy rate is high based on the line occupancy rate owned by the communication device of the uncontracted company.

In accordance with a third aspect of the present invention, provided is an Internet roaming method of a prepaid system at a communication device of a provider having a plurality of access servers and an authentication server for communicating with the access servers for providing the Internet dialup connection services. Here, the Internet roaming method of the prepaid system comprises the steps of: enabling, between a communication device of the contracted company which a user has a contract with and a communication device of an uncontracted company which the user does not have a contract with, the user to make connection to the access server of the uncontracted company, by querying about information of the user to the authentication server of the contracted company by the authentication server of the uncontracted company when the user makes connection to an access server in the communication device of the uncontracted company; notifying, by the authentication server of the contracted company contracted by the user, the authentication server of the uncontracted company of remaining units indicating a period of time which the user is entitled to connection, when the user who has a contract of a prepaid system for prepaying fees for particular connection time makes connection to the uncontracted company which the user does not have a contract with; and notifying, by the authentication server of the uncontracted company, the authentication server of the contracted company of remaining units obtained by subtracting the period of the connection time by the user to the uncontracted company, when there is a request from the authentication server of the contracted company.

### BRIEF DESCRIPTION OF THE DRAWINGS

FIG. 1 is a configuration view of a network.

FIG. 2 is a sequential view of a roaming connection (initial connection).

FIG. 3 is a sequential view of a roaming connection (reconnection).

FIG. 4 is a flowchart showing an authentication operation 1 of an uncontracted company RADIUS.

FIG. 5 is a view illustrating an information table of a contracted company.

FIG. 6 is a flowchart showing an authentication operation of a contracted company RADIUS.

FIG. 7 is a view illustrating an information table of an uncontracted company.

FIG. 8 is a view illustrating a user information table a-1 of the contracted company.

FIG. 9 is a view illustrating a user information table.

FIG. 10 is a sequential view of connection at a contracted company A.

FIG. 11 is a flowchart showing updating of a RADIUS user information table of the contracted company A.

FIG. 12 is a flowchart showing updating of a RADIUS user information database of an uncontracted company B.

FIG. 13 is a sequential view of periodic deletion of a user information database.

FIG. 14 is a view illustrating a user information table b of the contracted company A.

FIG. 15 is a view illustrating a user information table c of the contracted company A.

FIG. 16 is a sequential view of accounting information notification.

FIG. 17 is a constitutional view of an accounting information table.

FIG. 18 is a flowchart showing an authentication operation 2 of the uncontracted company RADIUS.

FIG. 19 is a view illustrating a user information table a-2 of the contracted company.

FIG. 20 is a view illustrating a user information table a-3 of the contracted company.

FIG. 21 is a flowchart of an accounting operation of a prepaid system of the uncontracted company RADIUS.

FIG. 22 is a view illustrating a user information database.

FIG. 23 is a view illustrating a weighing table.

### DESCRIPTION OF THE PREFERRED EMBODIMENTS

A. Configuration

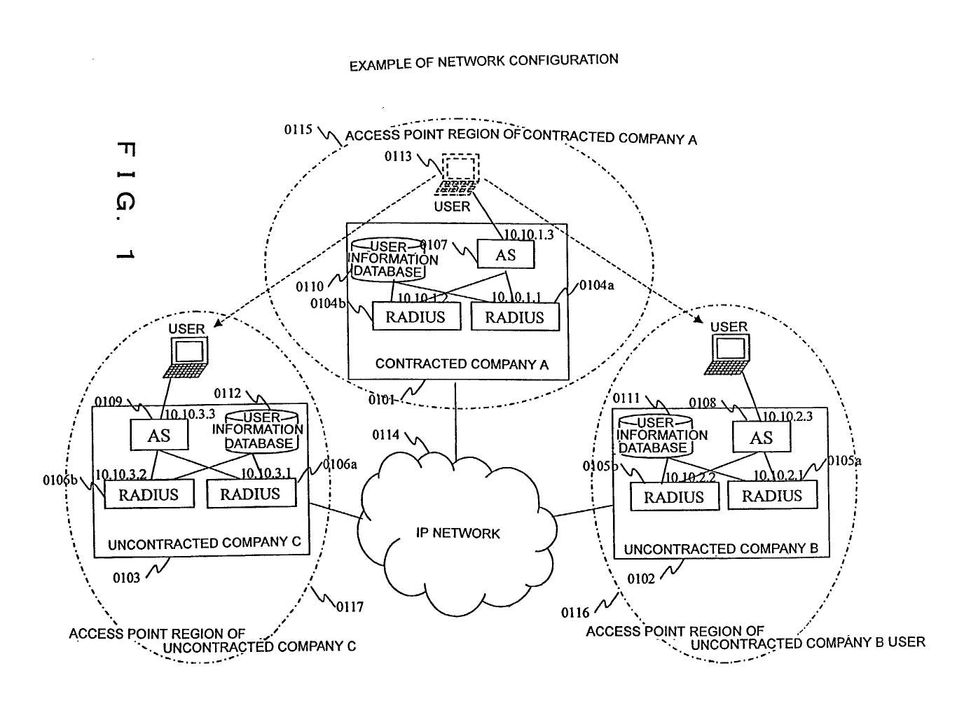

Next, embodiments of the present invention will be described with reference to the accompanying drawings. FIG. 1 shows an example of a provider roaming network configuration, to which the present invention is applied.

The provider roaming network comprises: a user (0113) utilizing the Internet by a dialup connection; a contracted company A (0101) as a provider, which the user has made contract for a dialup connection service with; an uncontracted company B (0102) for performing provider roaming with the contracted company A (0101); an uncontracted company C (0103); and an IP network (0114). The contracted company A (0101) includes: an access server (hereinafter referred to as an “AS”) (0107) for connecting a dialup action with the IP network (0114); a remote authentication dial in user service (RADIUS) (0104a/b) for performing communications with the AS (0107) regarding authentication and accounting through the IP network; and a user information database (0110) for storing the information of a user having a contract with the contracted company A (0101). The uncontracted company B (0102) includes: an AS (0108) for connecting a dialup action with the IP network (0114); a RADIUS (0105a/b) for performing communications with the AS (0108) regarding authentication and accounting through the IP network (0114); and a user information database (0111) for storing the information of a user having a contract with the uncontracted company B (0102). The uncontracted company C (0103) includes: an AS (0109) for connecting a dialup action with the IP network (0114); a RADIUS (0106a/b) for performing communications with the AS (0109) regarding authentication and accounting through the IP network; and a user information database (0112) for storing the information of a user having a contract with the uncontracted company C (0103). In the embodiment, the numbers of AS and RADIUS units in each company are respectively one and two. However, the numbers of AS and RADIUS units in each company can be freely set according to each company or a predetermined setting/system configuration.

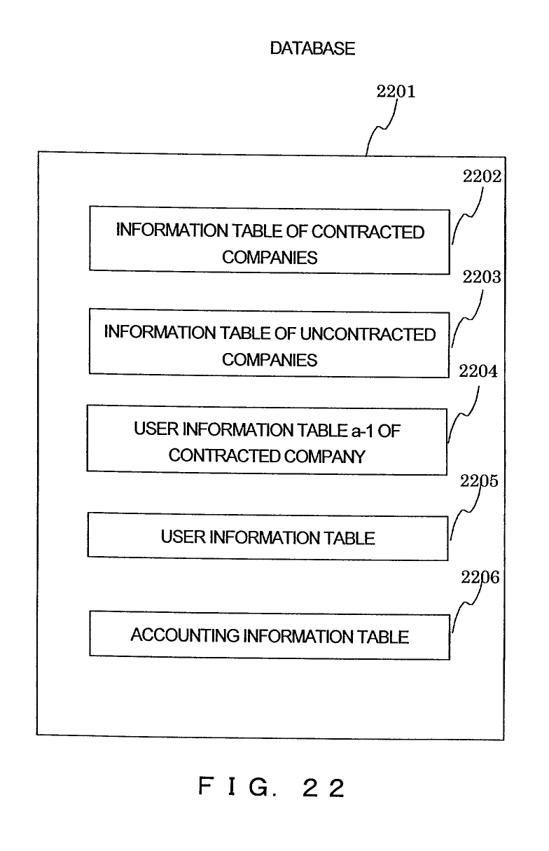

FIG. 22 illustrates a user information database. Each user information database 2201 includes: an information table of a contracted company (2202); an information table of an uncontracted company (2203); a user information table of the contracted company (2204); a user information table (2205); and an accounting information table (2206) (each table is described in detail later).

B. Roaming Operation

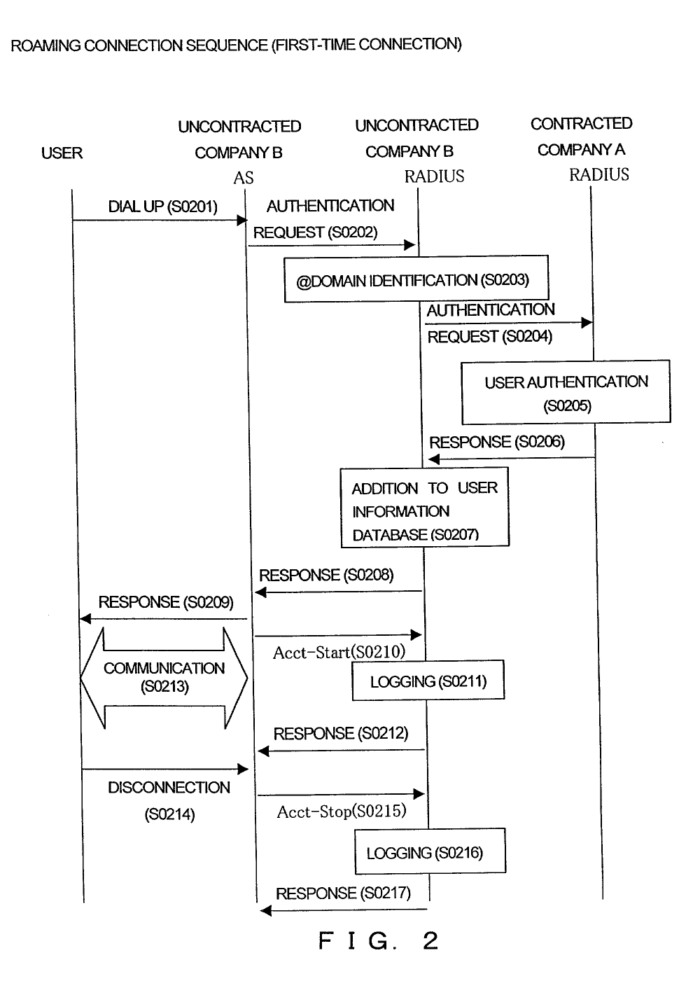

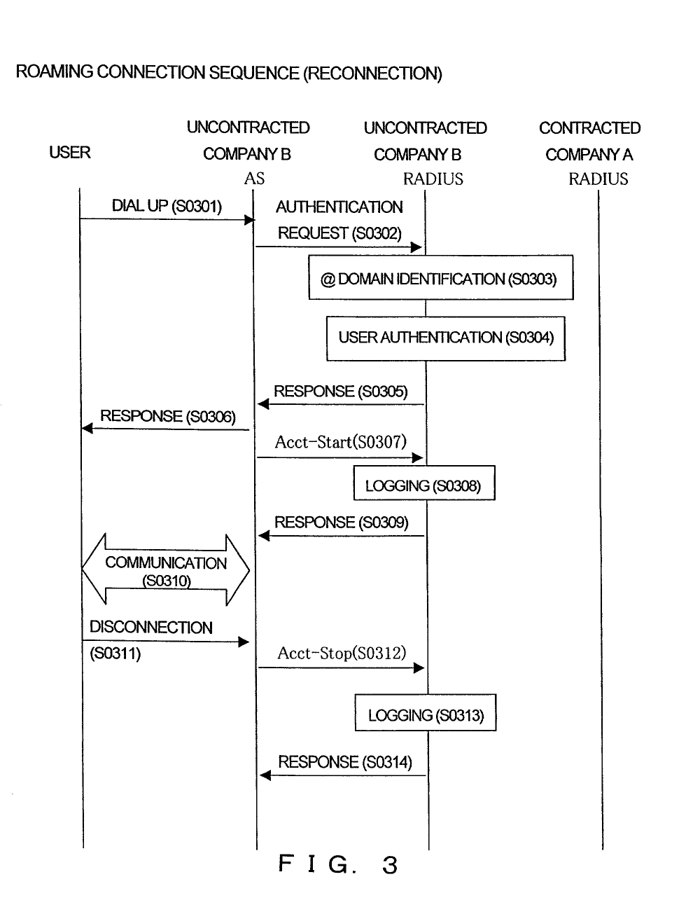

FIGS. 2 and 3 are respectively roaming connection sequential views of a first connection and a reconnection. By referring to these drawings, description will be made for a roaming operation sequence in the case when the user (0113) executes dialing-up in an access point region of the uncontracted company B. Each step of respective flowcharts is executed by a central processing unit (CPU), RADIUS or the like provided in the communication device of each company.

FIG. 2 shows a sequence when the user (0113) executes dialing-up for the first time in the access point of the uncontracted company B, or alternatively, when the user (0113) executes dialing-up in a state that user information of the user (0113) has not been registered in the user information database (0111) of the uncontracted company B.

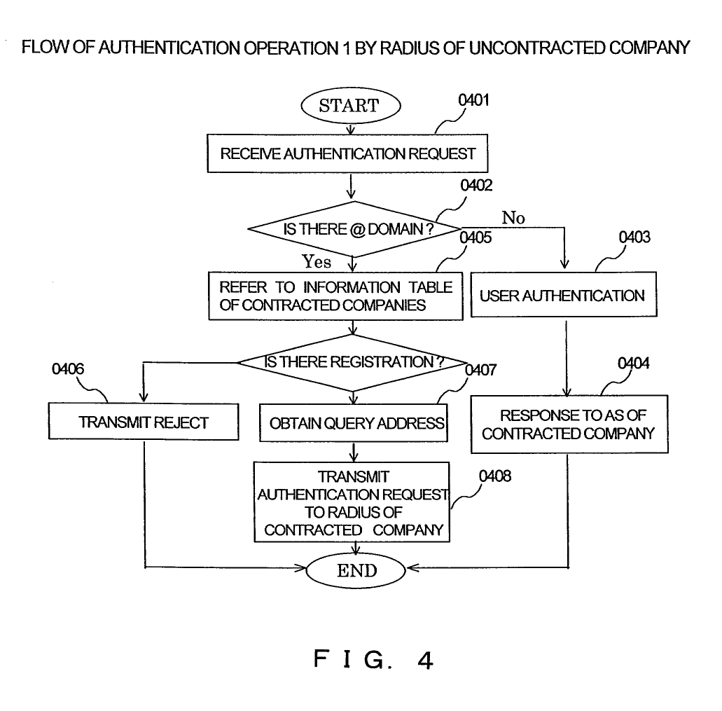

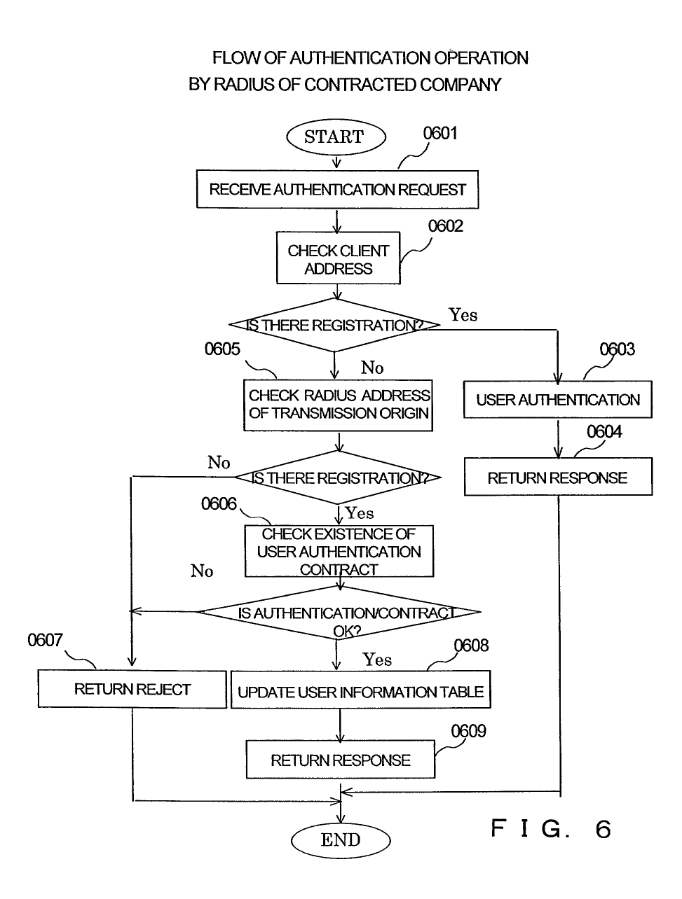

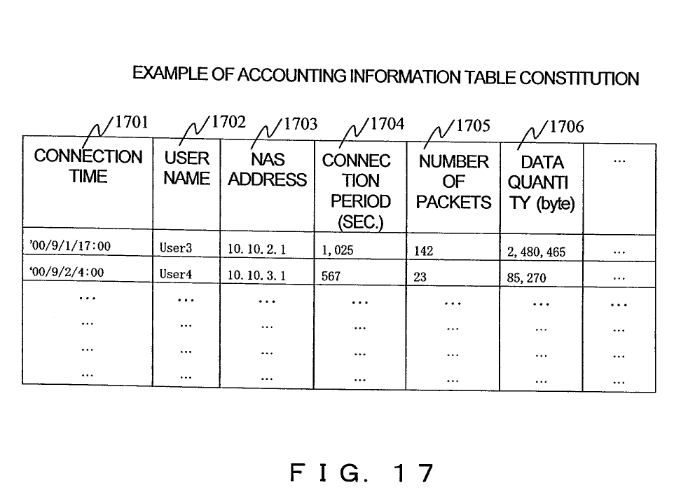

The user (0113) dials up to the AS (0108) of the uncontracted company B by adding “@domain name” after a user ID manually or automatically (S0201). The AS (0108) of the uncontracted company B makes an authentication request to the RADIUS (0105a/b) of the uncontracted company B (S0202). Upon receiving the authentication request (S0202), the RADIUS (0105a/b) of the uncontracted company B performs @ domain identification by an authentication operation as described later by referring to FIG. 4 (S0203), and then makes an authentication request to the RADIUS (0104a/b) of the contracted company A (S0204). Upon receiving the authentication request (S0204), the RADIUS 0104a/b) of the contracted company A performs user authentication by an authentication operation as described later by referring to FIG. 6 (S0205), and then transmits a response to the RADIUS (0105a/b) of the uncontracted company B. Upon receiving the authentication response, the RADIUS (0105a/b) of the uncontracted company B adds the information of the authenticated user (0113) to the user information table of the user information database (0111) (S0207), and then transmits the response (S0208) of the authentication request (S0202) to the AS (0108) of the uncontracted company B. Upon receiving the response (S0208), the AS (0108) of the uncontracted company B transmits a response (S0209) to the user (0113), and simultaneously transmits Acct-Start (S0210) as an accounting packet to the RADIUS (0105a/b) of the uncontracted company B. Upon receiving the Acct-Start (S0210), the RADIUS (0105a/b) of the uncontracted company B performs logging (recording, log-in) in a below-described accounting information table shown in FIG. 17 (S0211), and then transmits the response (S0212) to the AS (0108) of the uncontracted company B. Accordingly, the user (0113) is set in a communication state (S0213) with the AS (0108) of the uncontracted company B.

At the end of the communication, the user (0113) disconnects the line (S0214), and the AS (0108) of the uncontracted company B transmits Acct-Stop (S0215) as an accounting packet for communication completion to the RADIUS (0105a/b) of the uncontracted company B. Upon receiving the Acct-Stop (S0312) as the accounting packet, the RADIUS (0105a/b) of the uncontracted company B performs logging in the accounting information table (S0216) as described later by referring to FIG. 17, and transmits a response (S0217) to the AS (0108) of the uncontracted company B.

Next, FIG. 3 shows a sequence in the case when the user (0113) makes a connection again in the access point region of the uncontracted company B in a state where the user information of the user (0113) has been registered with the user information database (0111) of the uncontracted company B.

The user (0113) dials up to the AS (0108) of the uncontracted company B by adding “@ domain name” after a user ID manually or automatically (S0301). The AS (0108) of the uncontracted company B makes an authentication request to the RADIUS (0105a/b) of the uncontracted company B (S0302). Upon receiving the authentication request (S0302), the RADIUS (0105a/b) of the uncontracted company B performs @ domain identification (S0303) and user authentication (S0304) based on an authentication operation flow as described later by referring to FIG. 4, and then transmits a response (S0305) to the AS (0108) of the uncontracted company B. Upon receiving the authentication response, the AS (0108) of the uncontracted company B transmits response (S0306) to the user (0113), and simultaneously transmits Acct-Start (S0307) as an accounting packet to the RADIUS (01015a/b) of the uncontracted company B. Upon receiving the Acct-Start (S0307), as described later by referring to FIG. 17, the uncontracted company B performs logging in the accounting information table (S0308), and transmits a response to the AS (0108) of the uncontracted company B (S0309). Accordingly, the user (0113) is set in a communication state (S0310). At the end of the communication, the user (0113) disconnects the line (S0311), and the AS (0108) of the uncontracted company B transmits Acct-Stop (S0312) as an accounting packet for communication completion to the RADIUS (0105a/b) of the uncontracted company B. Upon receiving the Acct-Stop (S0312), the RADIUS (0105a/b) of the uncontracted company B performs logging in the accounting information table as shown in FIG. 17 (S0313), and then transmits a response to the AS (0108) of the uncontracted company B.

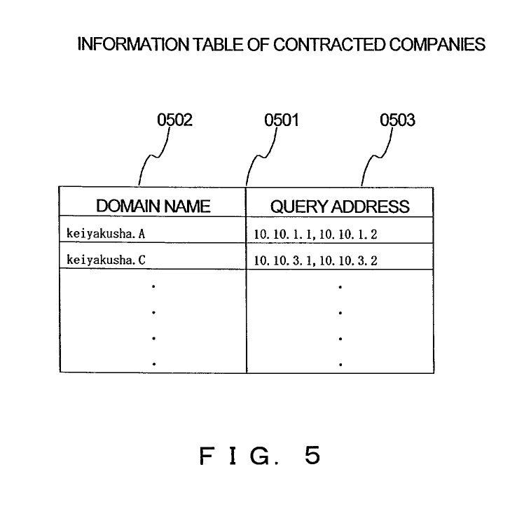

FIG. 4 is a flowchart showing an operation in the case when the RADIUS (0105a/b or 0106a/b) of an uncontracted company receives an authentication request from the AS (0108 or 0109) of the uncontracted company. In addition, FIG. 5 illustrates the information table of the contracted companies. Now, description will be made for an example in the case where a user (0113) having a contract with a contracted company A accesses an uncontracted company B (0102), and the AS (0108) of the uncontracted company transmits an authentication request to the RADIUS (0105a) of the uncontracted company.

Upon receiving the authentication request from the AS (0108) of the uncontracted company (0401), the RADIUS (0105a) of the uncontracted company checks on whether @ is added to a user name notified by the authentication request or not (0402). If no @ is added, then the RADIUS (0105a) identifies that the user is its own contracted user, executes user authentication by referring to its own user information table (0403), and returns a response to the AS (0108) of the uncontracted company (0404).

If the user name has @ added thereto, then the RADIUS (0106a) identifies that the user is an uncontracted user, and discovers a company contracted by the user (0113) by referring to the information table of the contracted companies (0501) shown in FIG. 5 (0405). In the information table of the contracted companies (0501) shown in FIG. 5, registered are a domain name (0502) and a query destination address (0503) to be queried for user information when an access is made by the domain name. This query address is a RADIUS address of a company indicated by the domain. For example, assuming that a domain name indicating the contracted company A is “keiyakusha. A” as an address to be queried, the addresses of the RADIUS (0104a) of a contracted company and the RADIUS (0104b) of a contracted company have been registered.

For example, in the case when a user (0113) makes connection to an uncontracted company B (0102), “user1@keiyakusha. A” is notified as a user name to the RADIUS (0105a) of the uncontracted company. Thus, the RADIUS (0150a) of the uncontracted company searches “keiyakusha. A” from the information table of the contracted companies (0501). If the information table of the contracted companies (0501) has “keiyakusha. A” registered therewith, the user (0113) is identified as a user having a contract with a company contracted for roaming with the uncontracted company, and then the address, i.e., the query address (0503) of the RADIUS of the contracted company which the user (0113) has a contract with, is obtained (0407). For example, when the user (0113) executes an access by “user1@keiyakusha. A”, “10. 10. 1.1” and “10. 10. 1.2” are obtained as query addresses. Then, the authentication request received from the AS (0108) of the uncontracted company is transmitted to one of the obtained query addresses, e.g., the address “10. 10. 1.1” of the RADIUS (0105a) of the contracted company (0408). For use of any of a plurality of query addresses, the addresses may be transmitted both or in a predetermined order, and the address which transmits back a response may be used. On the other hand, if the domain name added to the notified user name has not been registered with the information table of the contracted companies (0501), the access is determined as unlawful, and then “Reject” is transmitted to the AS (0108) of the uncontracted company which sent the authentication request, to inhibit its connection (0406).

If the domain name added to the notified user name has been registered with the information table of the contracted companies (0501), and when an authentication request is transmitted to a query destination, i.e., the RADIUS (0104a) of the contracted company, the process is placed on standby for a transmission of a response from the RADIUS (0104a) of the contracted company. In this case, a plurality of query addresses can be registered for one domain name in the information table of the contracted companies (0501). Hence, if there is no response from the RADIUS (0104a) of the contracted company, to which the authentication request was transmitted, the authentication request can be transmitted again to another query address, e.g., the RADIUS (0104b) of the contracted company. Then, as in the case of a general RADIUS, the process is placed on standby for a response from the RADIUS (0105a) of the uncontracted company.

Next, processing at the contracted company side will be described.

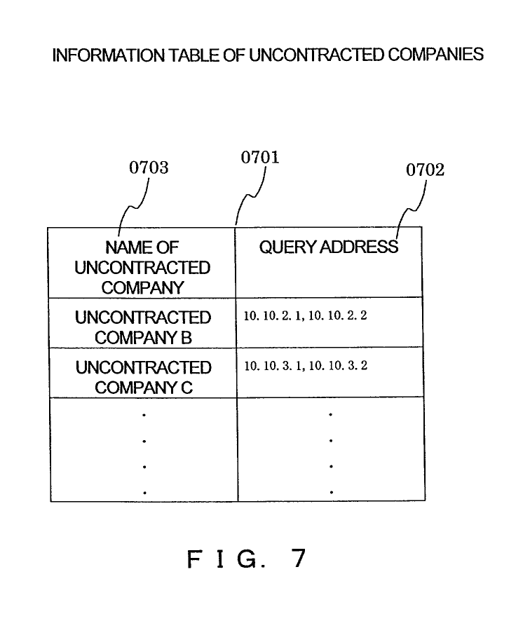

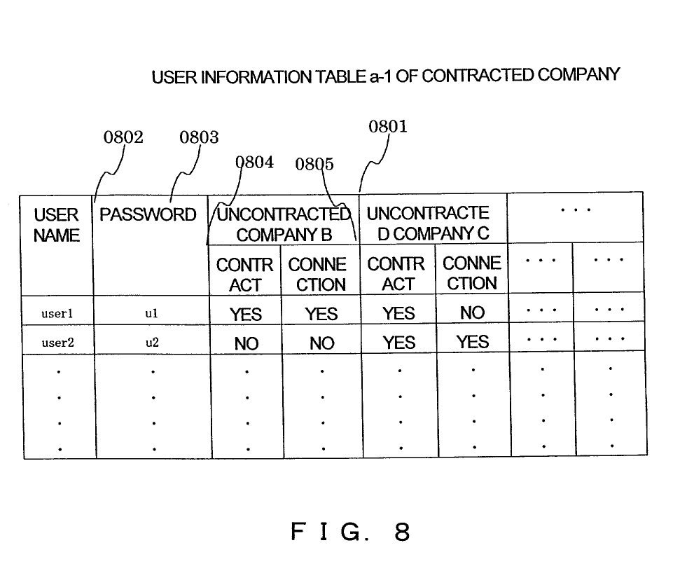

FIG. 6 is a flowchart showing an operation of the RADIUS (0104a/b) of a contracted company when an authentication request is received from the RADIUS (0105a/bor 0106a/b) of an uncontracted company. In addition, FIG. 7 illustrates the information table of the uncontracted companies, and FIG. 8 illustrates the user information table a-1 of the contracted company. Now, description will be made for an example where an authentication request is transmitted from the RADIUS (0105a) of the uncontracted company to the RADIUS (0104a) of the contracted company.

Upon receiving the authentication request (0601), as in the case of a general RADIUS server, the RADIUS (0104a) of the contracted company checks on whether the address of an origin of an authentication request transmission is registered or not as an internally stored client address (0602). If the address thereof has been registered as the client address, thereafter, as in the case of the general RADIUS server, a user name and a password are checked in order to execute user authentication by referring to the user information table, and a result thereof is transmitted to the origin of authentication request transmission (0603, and 0604).

On the other hand, if the address of the origin of the authentication request transmission has not been registered as the client address, then checking is executed on whether the address has been registered with an information table of the uncontracted companies (0701) as shown in FIG. 7 (0605). In the information table (0701) of the uncontracted companies, names of uncontracted companies (0703) contracted for roaming by the contracted company A (0101) and the RADIUS addresses of the uncontracted companies are registered as query addresses (0702). If the address of the origin of the authentication request transmission has been registered with the information table (0701) of the uncontracted companies, the received authentication request is identified as an authentication request accessed by a contracted user (0113) to the AS (0108) of the uncontracted company that the contracted company has a roaming contract with, and thereafter an operation in the case when the authentication request is received from the RADIUS of the uncontracted company is carried out. On the other hand, if the address of the origin of the authentication request transmission has not been registered with the information table (0701) of the uncontracted companies, then it is identified as an invalid authentication request from an invalid client, and “Reject” is transmitted to the origin of the authentication request transmission, thereby inhibiting its connection (0607).

If the address of the origin of the authentication request transmission has been registered with the information table (0701) of the uncontracted companies, then the RADIUS (0104a) of the contracted company performs user authentication and contract validity checking by using the user information table a-1 (0801) of the contracted company as shown in FIG. 8. In the user information table a-1 (0801) of the contracted company, in addition to a user name (0802) and a corresponding password (0803), contract validity (0804) indicating as to which uncontracted companies the user has a roaming contract with, and the connection existence (0805) of the user to such uncontracted company, are registered.

First, checking is executed on whether a user name (before @) in the authentication request transmitted from the RADIUS (0105a) of the uncontracted company has been registered or not as a user name (0802) on the user information table a-1 (0801) of the contracted company. If the user name has not been registered, then it is identified that the access has been made from an unlawful user, and “Reject” is transmitted to the RADIUS (0105a) of the uncontracted company, thereby inhibiting the connection of the user (0607). On the other hand, if the user has been registered as the user name (0802), it is identified that the access has been made from a contracted user, and password checking is carried out (0603). Here, if a password (0803) registered with the user information table a-1 (0801) of the contracted company is different from that notified by the authentication request, “Reject” is transmitted to the RADIUS (0105a) of the uncontracted company, thereby inhibiting the connection of the user (0607). On the other hand, if the passwords coincide with each other, it is determined that the access has been made from an authorized user, and next, checking is executed on whether the RADIUS of the uncontracted company which sent the authentication request is one which the user has a contract for roaming with or not (0606). In the user information table a of the contracted company (0801), regarding each uncontracted company, the information as whether a user has a roaming contract therewith has been registered (0804). When checking the address of the RADIUS (104a) of the transmission origin in step 0605, the RADIUS (0104a) of the contracted company obtains a name of the uncontracted company (0703) which owns the RADIUS of the address of the transmission origin, and checks in step 0606 on whether the user has a roaming contract with the uncontracted company or not. In the example shown in FIG. 8, the user 1 has a roaming contract with the uncontracted company B, while the user 2 has no roaming contract with the uncontracted company B. As a result of the contract existence checking, if it turns out that there is no roaming contract, then it is determined that the access is unlawful, and “Reject” is returned to the RADIUS (0105a) of the uncontracted company which sent the authentication request, thereby inhibiting the connection of the user (0607). On the other hand, if there is a roaming contract, table updating is carried out for the user information table a of the uncontracted company (0801) (0608). The RADIUS (0104a) of the contracted company refers to the item (0805) of the ‘existence of connection to the contracted company by the user' in the user information table a-1 (0801) of the contracted company. For example, when the user 1 accesses the uncontracted company B, the section of the existence of connection to the uncontracted company B by the user 1 is checked. If “NO” has been set, then the setting is changed to “YES”. If “YES”, this setting is maintained. In this connection existence section (0805), an initial value is set to “NO”. Thus, by setting the item (0805) to “YES” when the user accesses the uncontracted company, the RADIUS (0104a) of the uncontracted company can have information regarding which uncontracted company the contracted company's own user has accessed. After completion of the updating of the user information table a-1 (0801) of the contracted company, the RADIUS (0104a) of the contracted company transmits a response to the RADIUS (0105a) of the uncontracted company, which sent the authentication request (0609). Thereafter, connection processing is carried out at the uncontracted company side based on the operation after the authentication operation 1 flow 0409 by the RADIUS of the uncontracted company, as shown in FIG. 4.

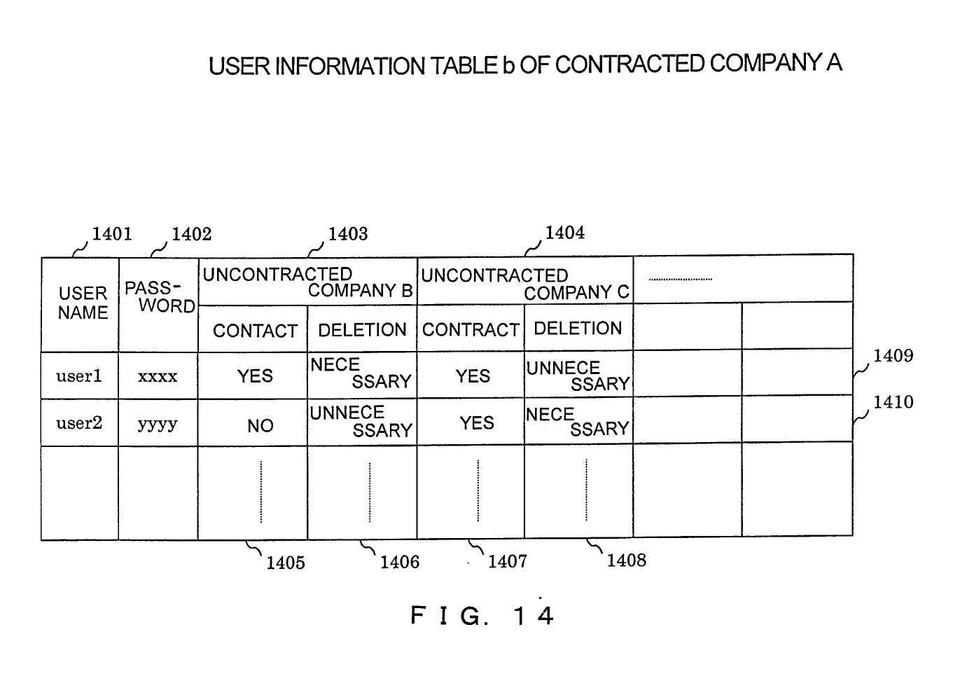

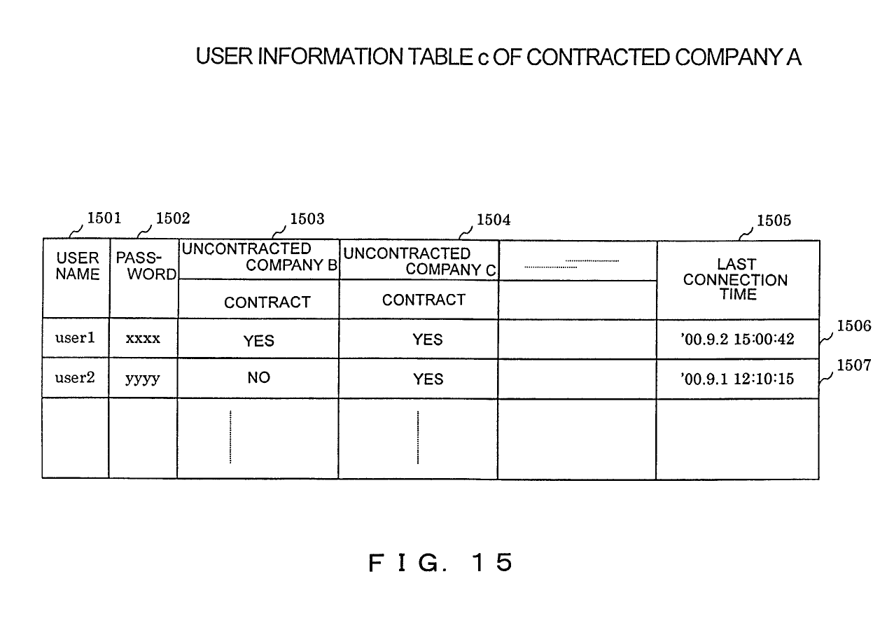

Another embodiment of the user information table of the contracted company is shown in FIGS. 14 and 15. In FIG. 14, instead of the connection existence (0805) described in FIG. 8, deletion necessity (1406, and 1408) is included. In FIG. 15, latest connection date (1505) is added.

C. Addition of User Information Database

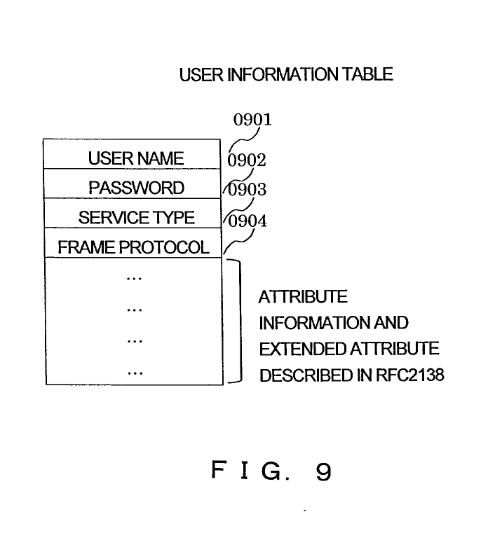

Next, description will be made for addition of a user information database (S0207) in the flowchart of FIG. 2. FIG. 9 illustrates a user information table. In the step of user information database addition (S0208), for example, attribute and extended attribute information described in RFC 2138 is extracted from PPP negotiation by dialing-up from the user (0113) and the response (S0206) of the RADIUS (0104a/b) of the contracted company A, and the information is registered with the user information database (0111) of the uncontracted company B as shown in FIG. 9. The information to be registered includes a user name (0901) of a user (0113) executed dialing-up in the access point region of the uncontracted company B by roaming between the providers, a password (0902) of the user, a service type (0903), a frame protocol (0904) and the like. Accordingly, when the user (0113) makes connection again in the access point region of the uncontracted company B, authentication can be performed by the RADIUS (0105a/b) of the uncontracted company B.

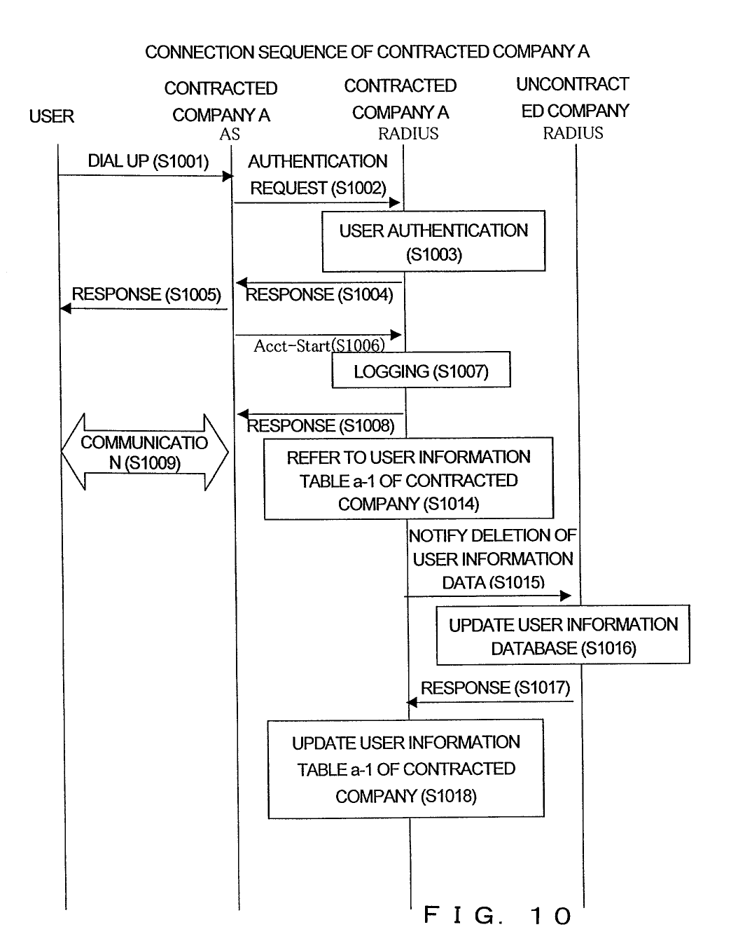

FIG. 10 is a sequential view of an operation when the user (0113) makes connection again in an access point region of the contracted company A.

The user (0113) dials up to the AS of the contracted company A (51001), and the AS makes an authentication request to the RADIUS of the contracted company A. Upon receiving the authentication request, depending on a table type, the RADIUS (0104) of the contracted company A refers to either of the user information table a-1 of the contracted company shown in FIG. 8, the user information table b of the contracted company shown in FIG. 14, or the user information table c of the contracted company shown in FIG. 15, and performs user authentication based on the user name and the password (S1003). If the authentication is successful, a response is transmitted to the AS of the contracted company (S1004). Upon receiving the authentication response, the AS of the contracted company A transmits the response to the user side (S1005), and simultaneously transmits “Acct-Start” as an accounting packet (S1006). Upon receiving the Acct-Start (S1006), the RADIUS (0104) of the contracted company A performs logging of accounting information in the accounting table as shown in FIG. 17 (S1007), and transmits a response (S1008) to the AS of the contracted company A. Accordingly, the user (0113) is placed in a communication state (S1009).

D. Deletion of User Information Database

Next, description will be made for a method of deleting data in the user table of the user information database. Objects of deletion may be, for example, the effective utilization of a memory capacity by deleting unnecessary information, the assurance of security of personal information, and the like.

As an example of a method of deleting the user information database (0111, or 0112) in the RADIUS of the uncontracted company, for each successful user authentication (S1003), the RADIUS (0104) of the contracted company A proceeds to a process for deleting the information database regarding the user (0113) currently dialing up, which is stored in a RADIUS of an uncontracted company, e.g., the RADIUS (0106) of the uncontracted company B. The RADIUS (0104) of the contracted company A refers to the user information table a-1 of the contracted company as shown in FIG. 8, and then transmits a notice of user information data deletion to the RADIUS of the uncontracted company, e.g., the RADIUS (0105) of the uncontracted company B, when deletion is necessary (S1015). Upon receiving the notice, the RADIUS of the uncontracted company, e.g., the RADIUS (0106) of the uncontracted company B, updates a user information table as shown in FIG. 9 (S1016), and transmits a response to the RADIUS (0104) of the contracted company A after updating (S1017). Upon receiving the deletion response from the relevant RADIUS of the uncontracted company, the RADIUS of the contracted company A updates the connection existence section of the uncontracted company of an origin of the response transmission in the contracted company user information table a-1 shown in FIG. 8 to a “NO” state (S1018). Accordingly, it is indicated that there is not user information in the relevant uncontracted company.

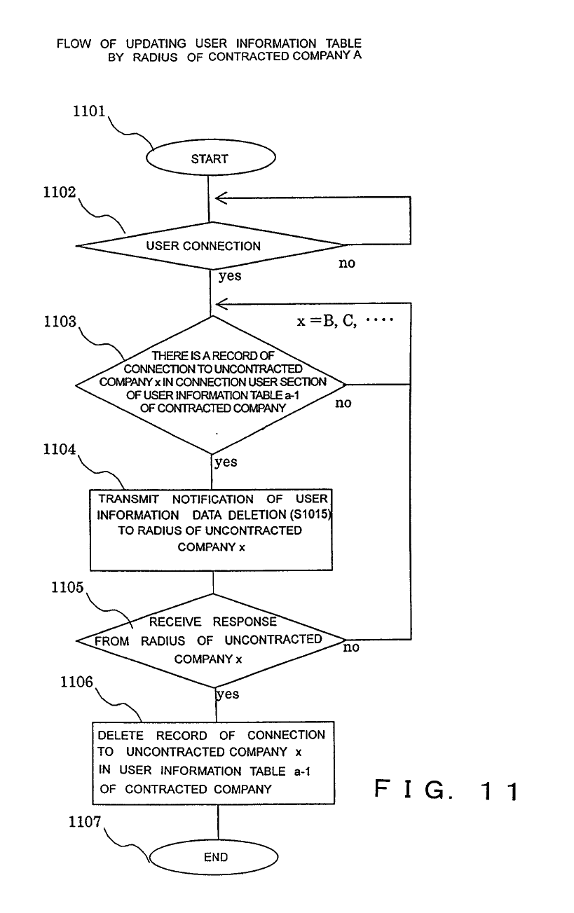

FIG. 11 shows a flow of updating of the user information table by the RADIUS (0104) of the contracted company A, when the RADIUS (0104) of the contracted company A transmits a deletion request of user information database (0111, and 0112) to the RADIUS of the uncontracted company in the event of each successful user authentication as shown in the example of FIG. 10.

When the user (0113) makes connection (1101), the RADIUS (0104) of the contracted company A refers to the user information table a-1 of the contracted company shown in FIG. 8, and determines the connection record of an uncontracted company based on connection existence (0805) in the information section of the connecting user (0113), for example by the uncontracted company B in order (1103). For example, when there is a connection record in the uncontracted company B, a notice of user information data deletion (S1l05) is transmitted to the RADIUS (0105) of the uncontracted company B (1104). When a response to the notice is received from the uncontracted company B (1105), the RADIUS (0104) of the contracted company A updates the connection record of the user connected to the uncontracted company (0113) in the user information table a-1 of the contracted company shown in FIG. 8, to “NO” (1106). The deletion processing is performed with reference to the user information table a-1 of the contracted company, on every uncontracted company the connecting user is accessible, and thus the user information table is updated.

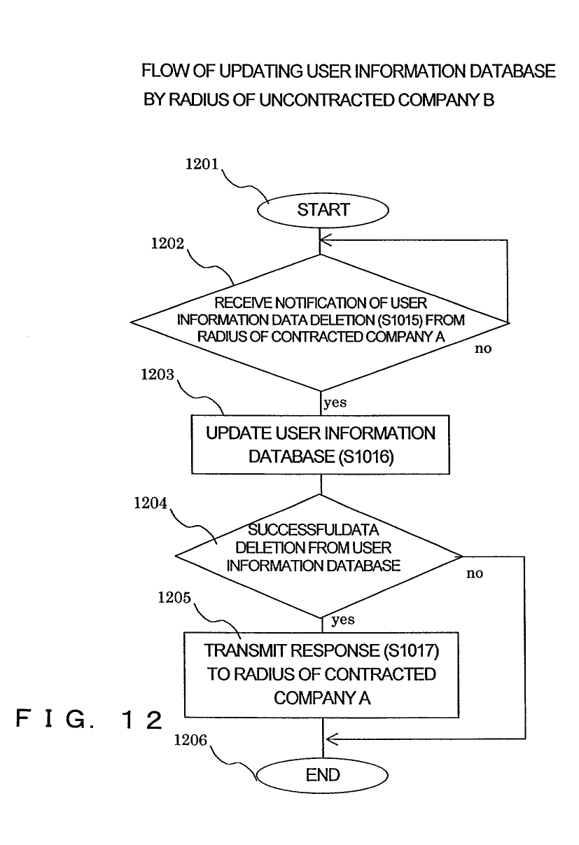

FIG. 12 shows a flow of updating the user information database (0111) by the RADIUS of the uncontracted company, e.g., the RADIUS (0105) of the uncontracted company B.

Upon receiving a deletion notice of the user information data (S1015) from the RADIUS (0104) of the contracted company A, the RADIUS (0105) of the uncontracted company B deletes and updates the user information of the relevant user (0113) from the user information table shown in FIG. 9 (1204). Upon successful deletion (1204), the RADIUS (0105) of the uncontracted company B transmits a response to the RADIUS of the contracted company A (1205).

In addition, in a case when the user (0113) makes connection to the uncontracted company C (0103) and an authentication request is made to the RADIUS (0104) of the contracted company A, the RADIUS (0104) of the contracted company A may verify the section of connection existence (0805) to companies other than the uncontracted company C (0103) by referring to the user information table a-1 of the contracted company shown in FIG. 8. For example, when the record of connection to the uncontracted company B (0102) is “YES”, then as shown in the step 1103 and thereafter in FIG. 11, the user information deletion process may be carried out for the RADIUS (0105) of the uncontracted company B.

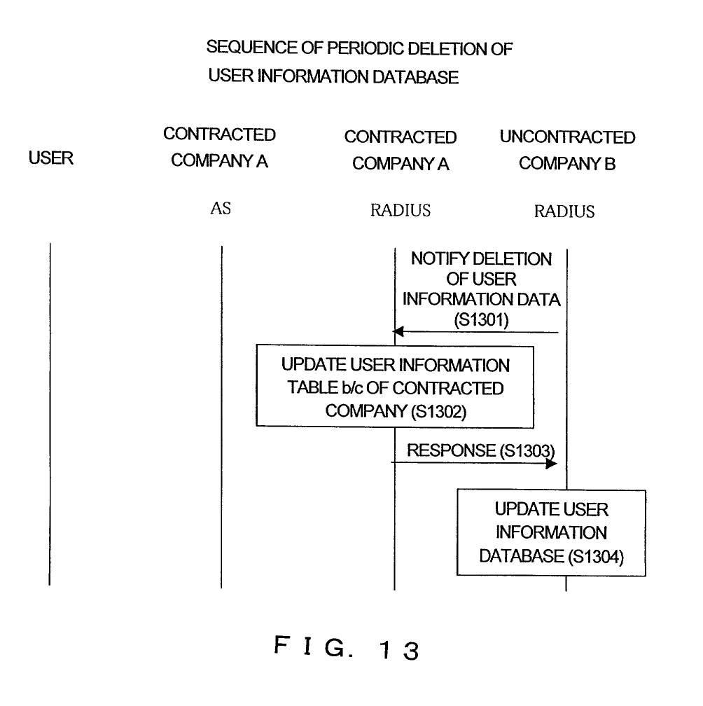

FIG. 13 shows another example of a method of deleting the user information database (0111, or 0112) in the RADIUS of the uncontracted company. Here, a case in which a deletion notice regarding the user information database (0111) is periodically executed from the uncontracted company, e.g., the RADIUS (0105) of the uncontracted company B, will be described. In this case, the term “periodically” refers to a period set by the uncontracted company, for example, once per 12 hours, once a day or the like.

At a predetermined date and time, the RADIUS (0105) of the uncontracted company B notifies a deletion of all of the user information in the user information table in the RADIUS (0105) of the uncontracted company B as shown in FIG. 9, to the RADIUS (0104) of the contracted company A (S1301). Upon receiving the notice, the RADIUS (0104) of the company A updates the user information table b of the contracted company shown in FIG. 14 or the user information table c of the contracted company shown in FIG. 15 (S1302), based on certain steps. After updating the table, a response is transmitted to the RADIUS (0105) of the uncontracted company B (S1303). The RADIUS (0105) of the uncontracted company B deletes and updates the user information of the contracted company A (0101) out of the user information table shown in FIG. 9 (S1304).

In this case, if the user information table b of the contracted company shown in FIG. 14 is used as a user information table of the contracted company, management of the table can be carried out based on an algorithm as shown below. First, as an initial state, “UNNECESSARY” is set in a deletion necessity section (1406) of the uncontracted company of the user (0113). When an authentication request is made from each uncontracted company to the RADIUS (0104) of the contracted company A, the RADIUS (0104) of the contracted company A updates the deletion necessity section (1406) of the uncontracted company of the request origin regarding the requested user, to “NECESSARY” (0113). Based on periodical deletion notices of the user information received from the contracted company, the deletion necessity section (1406) of the uncontracted company is updated to “NO” again. It can be understood that user information has been stored in the RADIUS of the uncontracted company, where “NECESSARY” is set in the deletion necessity section (1406) thereof.

In addition, as means for deleting the user information based on deletion notices of the user information data periodically received from the RADIUS (0105) of the uncontracted company B as shown in FIG. 13, the user information table c of the uncontracted company shown in FIG. 15 can be also used.

In this case, the RADIUS (0104) of the contracted company A must update the latest connection date and time (1505) in the event of each connection by the user (0113) in the access point region of the contracted company A, and the RADIUS of the uncontracted company must have the latest connection date and time of the user (0113) in the access point region of the uncontracted company, in the user information table shown in FIG. 9. Upon receiving the periodical deletion notice of user information data from the RADIUS (0105) of the uncontracted company B, the RADIUS (0104) of the contracted company A notifies the latest connection date and time in the access point region of the contracted company A in a response message. Upon receiving this message, the uncontracted company compares the latest connection date and time in the message with the latest date and time (1505) in the access point region of the uncontracted company, then decides that the user (0113) has moved to the access point region of the contracted company A if the latest connection time (1505) in the access point region of the contracted company A is later, and deletes the user information of the contracted company A in the RADIUS (0105) of the uncontracted company B.

E. Accounting

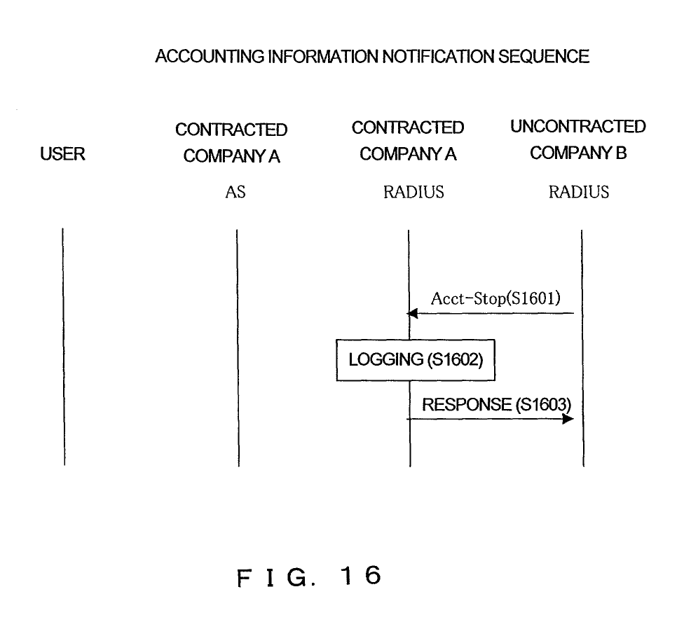

Next, description will be made for notification of accounting information of the user (0113) regarding roaming connection by referring to FIGS. 16 and 17. FIG. 16 shows a sequence of notification of accounting information between the RADIUS (0104a/b) of the contracted company A and the RADIUS (0150a/b) of the uncontracted company B. FIG. 17 shows an accounting information table of a user having a contract with another company who made provider roaming connection, the table which is held in the user information database of the uncontracted company B. The accounting information table of FIG. 17 includes: connection date and time (1701); a user name (1702) who made dialing-up connection; a Network Access System (NAS) address indicating an IP address of a RADIUS of the company with which the user who made the dialup connection has a contract for a connection service; connection period (1704) indicating a time zone of the connection by the user who made the dialup connection; the number of packets (1705) communicated by the user who made the dialup connection; a data quantity (1706) communicated by the user who made the dialup connection; and other information such as attribute information and extended attribute information as described in the RFC 2139. The information on the accounting information table is extracted from an accounting reckoning by the existing logging of the company. In notification of accounting information as shown in FIG. 16, the RADIUS (0105a/b) of the uncontracted company B extracts the information of the accounting table for the contracted company A based on the NAS address (1703) of the accounting information table, and the accounting information is transmitted to the RADIUS (0104a/b) of the contracted company A of the NAS address by use of the Acct-Stop (S1601). On the other hand, the RADIUS (0104a/b) of the contracted company A receives the Acct-Stop (S1601), performs logging of the received information (S1602), and transmits a response to the RADIUS (0105a/b) of the uncontracted company B.

F. Authentication

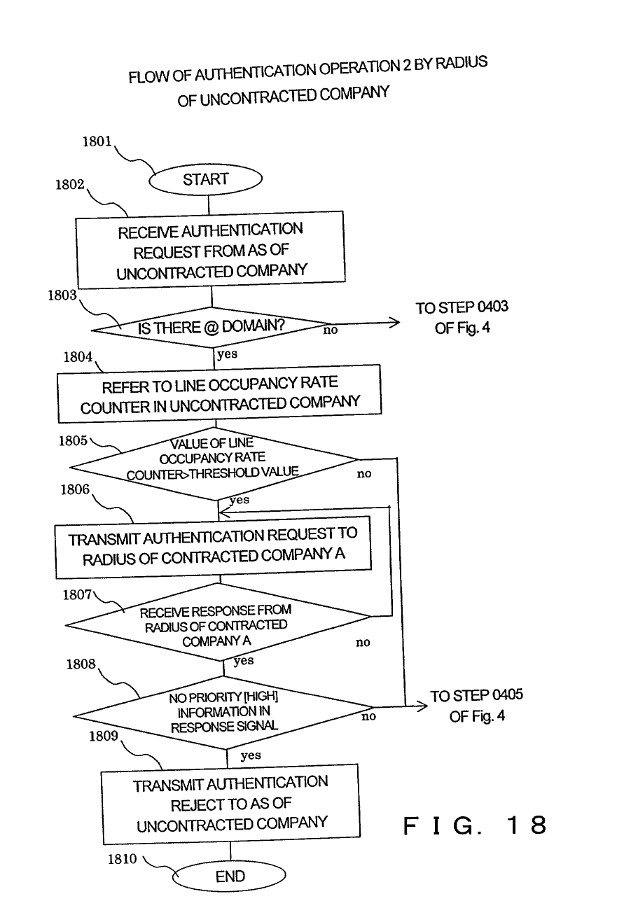

FIG. 18 shows a flow of an authentication operation 2 by the RADIUS of the uncontracted company when the user (0113) makes connection to the uncontracted company, and when connection determination is made at the RADIUS of the uncontracted company based on the contract existence of the user (0113).

When a RADIUS of an uncontracted company, e.g., the RADIUS (0105) of the uncontracted company B, receives a user authentication request (1802) from the AS (0108) of the uncontracted company B, determination is made as to whether there is a “@ domain” in the user name attribute contained in the authentication request signal (1803). If there is no “@ domain”, processing moves to the authentication process by judging that the request is regarding a user (0113) of the uncontracted company B (0103) as shown by the step 0403 and thereafter in FIG. 4. If there is “@ domain” in the user name attribute, since the user is the uncontracted user (0113) of the uncontracted company B (0103), reference is made to an occupancy rate counter indicating a line occupancy rate in the uncontracted company B (0103) (1804). A value indicated by the occupancy rate counter is compared with a predetermined threshold value of an occupancy rate (1805). If the value of the occupancy rate counter is not larger than the threshold value, it means that additional user connection is available in the uncontracted company B (0103), and thus processing moves to the user connection process as shown in the step 0405 and thereafter in FIG. 4. If the value of the occupancy counter exceeds the threshold value, firstly, an authentication request regarding the user (0113) is transmitted to the RADIUS (0104) of the contracted company A (1806). Upon receiving a response to the authentication request (1807), if information identifying a priority is present in the response signal, and the information indicates a “high” priority (1808), then the user (0113) of the contracted company A (0101) is allowed to connect to the uncontracted company B (0103) even if the threshold value of the occupancy rate is exceeded, and processing moves to the user connection process of the step 0405 and thereafter in FIG. 4. However, if there is no information identifying a priority contained in the authentication response signal, or if the priority is “low” even when information is present therein (1808), connection is not admitted by the uncontracted company B (0103), and an authentication reject signal is transmitted to the AS (0108) of the uncontracted company B (1809).

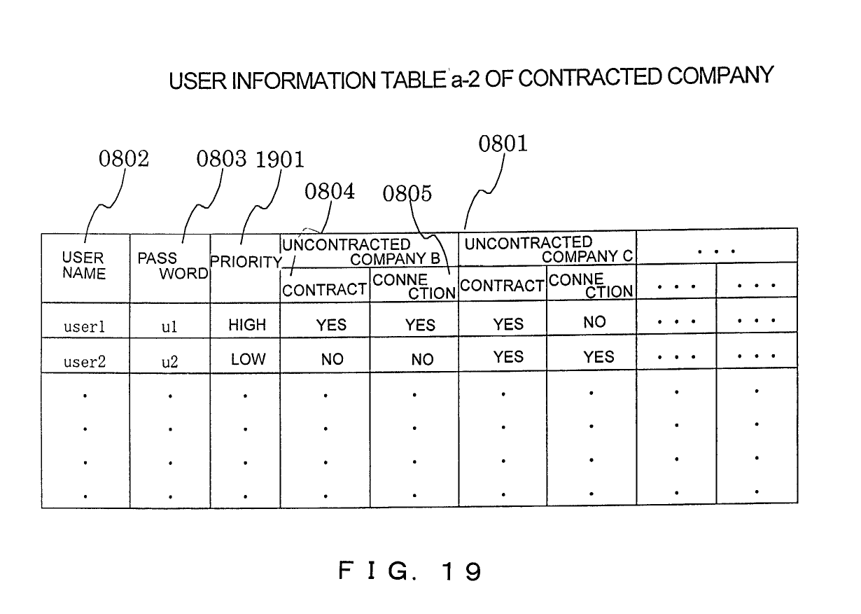

With regard to the priority used here for each user (0113), as shown in the user information table a-2 of the RADIUS of the contracted company in FIG. 19 for example, the priority (1901) of the relevant user (0113) is set in the user information table. And the RADIUS (0104) of the contracted company A that received the authentication request may execute authentication, and then, may notify the priority of the user (0113) by containing into the response signal to the RADIUS (0105) of the uncontracted company B. As a notification method, a new extended attribute may be additionally provided in the authentication response message.

If the value of the occupancy rate counter exceeds the threshold value in FIG. 18 (1805), without moving to the process of identifying the priority, the RADIUS (0105) of the uncontracted company B may immediately transmit authentication rejection to the AS (0108) of the uncontracted company B (1809), and may reject any connection by a user (0113) having a contract with a company other than the uncontracted company B (0103) in excess of the threshold value.

G. Prepaid system

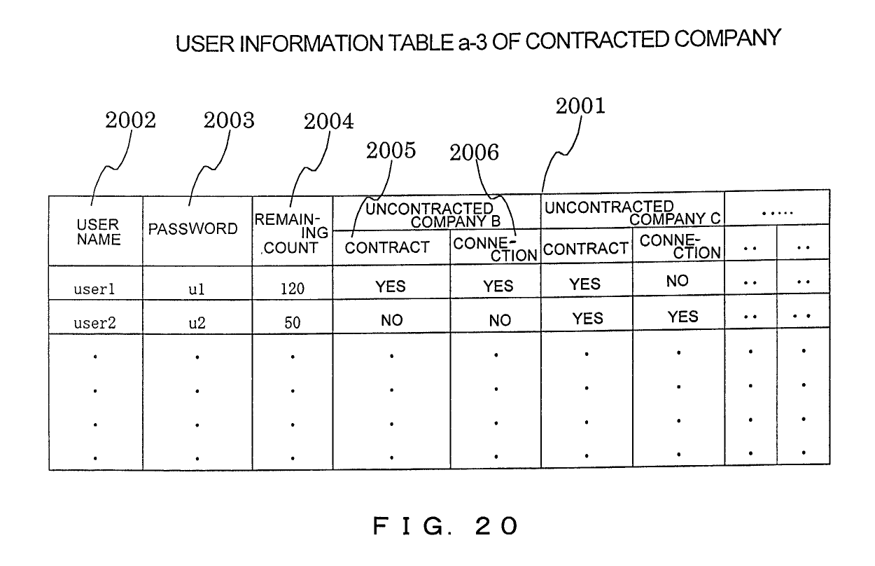

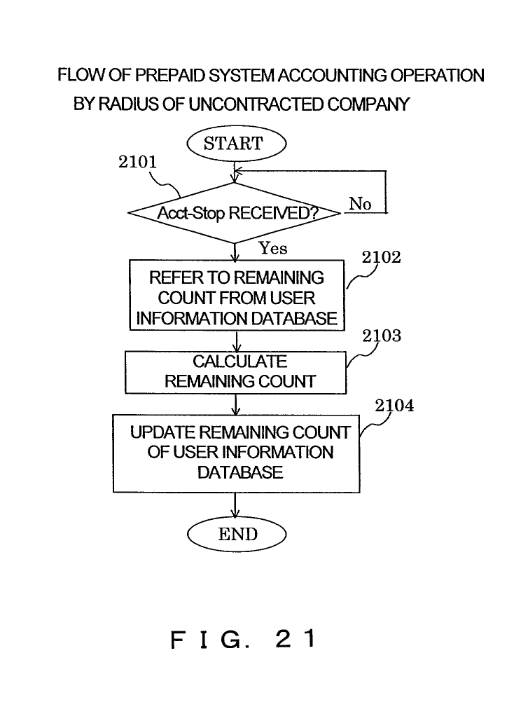

FIG. 20 illustrates a user information table a-3 of the contracted company. In addition, FIG. 21 is a flowchart showing an accounting operation under a prepaid system by the RADIUS of the uncontracted -company. Now, by referring to FIGS. 2, 20 and 21, description will be made for roaming connection using prepaid accounting. Prepaid accounting is an accounting system, wherein a user prepays time fees for performing roaming connection, and purchases prepaid units in advance. Therefore, the user is entitled to use the prepaid units the user contracted at a roaming site. In the roaming connection with the prepaid accounting, the contracted company A (0101) holds a user information table a-3 of the contracted company as shown in FIG. 20. And the RADIUS (0104a/b) of the contracted company A adds a value of remaining prepaid units (hereinafter referred to as the “balance” (2004)) stored in the user information table a-3 of the contracted company, to the response (S0206) of FIG. 2 as an extended attribute, and transmits the response (S0206) to the RADIUS (0105a/b) of the uncontracted company B. Upon receiving the response (S0206), the RADIUS of the uncontracted company B registers the balance received as the extended attribute in the event of user information database addition (S207) as the balance information into the user information database, and transmits a response (S0208) with time information of available period for roaming connection corresponding to the balance, setting it as a Session-Timeout attribute described in the RFC 2138. Upon receiving the response (S0208), the AS (0108) of the uncontracted company B enables the roaming connection by the user (0113) within the period of time corresponding to the value of the SessionTimeout attribute, and cuts off the roaming connection when the period corresponding to the value of the Session-Timeout attribute has passed.

In addition, when the user (0113) disconnects the roaming connection within the period corresponding to the value of the SessionTimeout attribute (S0214), upon receiving an “Acct-Stop” (2101) shown in FIG. 21, the RADIUS (0105a/b) of the uncontracted company B refers to the balance in the user information database (2102), and thereby refers to the balance before the current roaming connection by the user (0113) from the user information database. Then, the RADIUS (0105a/b) of the uncontracted company B performs the balance calculation (2103) to obtain units used from the Acct-Session-Time attribute value described in the RFC 2139 in the Acct-Stop, and calculates the remaining balance available for the roaming connection by the user (0113) from the referred balance and the used units, and then performs updating of the balance in the user information database (2104) to register the calculated balance of the user (0113) into the user information database.

Next, description will be made for a method of updating the balance stored in the user information table a-3 of the contracted company as shown in FIG. 20 which is owned by the contracted company A, by referring to FIGS. 11 and 12. Note that, the user information table a-1 of the contracted company shown in FIG. 11 is replaced by the user information table a-2 of the contracted company. Upon receiving an authentication request due to the connection of by user (0113), the RADIUS (0104a/b) of the contracted company A transmits the presence of the connection record (1103) of an uncontracted company x in a connecting user section of the user information table a-2 connection of the contracted company as shown in the flow of FIG. 11, and transmits a deletion notice of user information data (S1015) to the RADIUS of the uncontracted company x (1104). Upon receiving the deletion notice of the user information data (S1015), the RADIUS (0105a/b) of the uncontracted company B adds the information of the balance stored in the user information database to a response (S1017) in a flow of updating information database as shown in FIG. 12 (S1016) (1203), and transmits the response (S1017) to the RADIUS (0104a/b) of the contracted company A, when the data deletion success is “yes” at the user information database (S1017). Upon receiving the response (S1017), the RADIUS (0104a/b) of the contracted company A performs deletion of the connection record (1106) regarding the uncontracted company x in the user information table a-2 of the contracted company, as well as refers to the information of the balance added in the response (S1017), and then updates the balance in the user information table a-3 of the contracted company.

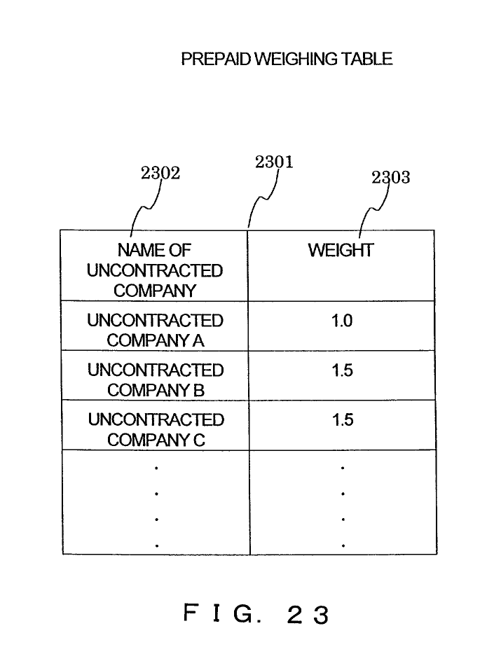

FIG. 23 illustrates a weighing table. In the roaming connection service of the prepaid accounting, a prepaid weighing table as shown in FIG. 23 is provided in each database. Thus, when the balance (2006) is added to the response (S0206) in FIG. 2, the balance is weighed by referring to a weight (2303), whereby making it possible to change connectable period of time for connection per unit between the cases when the user makes connection to the contracted company A and when the user makes connection to the company B or other companies.

In addition, by changing the value of weight (2303) in the prepaid weighing table with respect to each uncontracted company, it is possible to change connection period of time per unit depending on a destination of roaming connection.

The first object of the present invention is to provide the Internet roaming capable of solving the problems including an authentication failure due to a packet hiatus, a load on the backbone and the like, by relatively reducing the amount of user information communicated on the backbone, and also assuring security by performing authentication of a roaming user within a local network.

The second object of the present invention is to solve the problem of a decline of services for the contracted users, such as connection disabilities due to an increase of roaming connection, by giving priorities to the contracted users higher than those of the roaming users.

According to the present invention, especially when an uncontracted user makes connection to a uncontracted company, the authentication server of the uncontracted company registers the user information of the uncontracted user with its own user information table out of the information received from the uncontracted user and the information contained in the authentication response received from the authentication server of a contracted company. Thus, the uncontracted user can be connected without performing another query to the authentication server of the contracted company about user information when the uncontracted user makes a second-time connection or more. Therefore, according to the invention, it is possible to reduce the transfer of user information between the uncontracted company and the contracted company. Thus, a load placed on the backbone, and authentication failures due to packet losses are reduced, and the security is assured by user authentication only within the local network.

In addition, according to the invention, the authentication server of the uncontracted company may reject the connection by the uncontracted user when a line occupancy rate of its own network is high. Thus, it is possible to prevent a service decline for its own users due to providing a roaming service.

Furthermore, according to the invention, information regarding the balance of an accounting service under a prepaid system is transferred between the authentication server of the uncontracted company and the authentication server of the contracted company. Thus, it is possible to apply the accounting service of the prepaid system to the Internet roaming.

What is claimed is:

1. An Internet roaming method at a communication device of a provider having a plurality of access servers and an authentication server for communicating with the access servers for providing the Internet dialup connection services, the method comprising the steps of:
enabling, between a communication device of the contracted company which a user has a contract with and a communication device of an uncontracted company which the user does not have a contract with, the user to make connection to the access server of the uncontracted company, by querying about information of the user to the authentication server of the contracted company by the authentication server of the uncontracted company when the user makes connection to an access server in the communication device of the uncontracted company;
transmitting an authentication request of the user from the authentication server of the uncontracted company to the authentication server of the contracted company which the user has a contract with;
returning a response regarding the authentication request by the authentication server of the contracted company; and
registering, by the authentication server of the uncontracted company that received the response, user information of the uncontracted user in a user information table out of the user information received from the user and the information contained in the authentication response received from the authentication server of the uncontracted company.

2. The Internet roaming method according to claim 1, further comprising the step of:
allowing the authentication server of the uncontracted company to perform authentication of the uncontracted user by using the information registered in the user information table in the authentication server of the uncontracted company, thus enabling roaming connection by the uncontracted user to be made without queries to the authentication server of the contracted company, when the user makes a connection request again to the access server of the uncontracted company.

3. The Internet roaming method according to any one of claims 1 and 2, further comprising the step of:
allowing the authentication server of the contracted company to notify the authentication server of the uncontracted company to delete the user information of the user from the user information table included in the authentication server of the uncontracted company, when a content of the contract with the contracted company is changed.

4. The Internet roaming method according to any one of claims 1 to 3, further comprising the step of:
allowing the authentication server of the contracted company to notify the authentication server of the uncontracted company to which the user has made connection in the past to delete user information of the user from the user information table in the authentication server of the uncontracted company, when there is connection from the user who has made connection to the uncontracted company in the past.

5. The Internet roaming method according to any one of claims 1 to 3, further comprising the step of:
allowing the authentication server of the uncontracted company to query to the authentication server of the contracted company about the latest time when the uncontracted user made connection to the access server of the contracted company periodically or at a predetermined time, and to delete the user information of the uncontracted user from the user information table in the authentication server of the uncontracted company if the latest time when the uncontracted user made connection to the access server of the contracted company is determined to be after the latest time of connection to the access server of the uncontracted company.

6. The Internet roaming method according to any one of claims 1 to 5, further comprising the step of:
allowing the authentication server of the uncontracted company to record or to reckon accounting information regarding the user, and to transmit the recorded or reckoned accounting information to the authentication server of the contracted company which the user has a contract with, when the user makes connection to the access server of the uncontracted company which the user does not have a contract with.

7. An Internet roaming method at a communication device of a provider having a plurality of access servers and an authentication server for communicating with the access servers for providing the Internet dialup connection services, the method comprising the steps of:
enabling, between a communication device of the contracted company which a user has a contract with and a communication device of an uncontracted company which the user does not have a contract with, the user to make connection to the access server of the uncontracted company, by querying about information of the user to the authentication server of the contracted company by the authentication server of the uncontracted company when the user makes connection to an access server in the communication device of the uncontracted company;
identifying whether the user is a contracted user or an uncontracted user by a domain name or a user name by the authentication server of the uncontracted company; and
rejecting, by the server of the uncontracted company, connection by the uncontracted user to give priority to other users having contracts with the uncontracted company where the server of the uncontracted company identifies that the user is an uncontracted user and where a line occupancy rate is high based on the line occupancy rate owned by the communication device of the uncontracted company.

8. The Internet roaming method according to claim 7, further comprising the step of:
allowing the authentication server of the uncontracted company to obtain a priority of the user based on a user information table storing the priority for each uncontracted user, and to permit an uncontracted user having a high priority to make connection in spite of a case when a line occupancy rate of the uncontracted company is high.

9. An Internet roaming method of a prepaid system at a communication device of a provider having a plurality of access servers and an authentication server for communicating with the access servers for to providing the Internet dialup connection services, comprising the steps of:
enabling, between a communication device of the contracted company which a user has a contract with and a communication device of an uncontracted company which the user does not have a contract with, the user to make connection to the access server of the uncontracted company, by querying about information of the user to the authentication server of the contracted company by the authentication server of the uncontracted company when the user makes connection to an access server in the communication device of the uncontracted company;
notifying, by the authentication server of the contracted company contracted by the user, the authentication server of the uncontracted company of remaining units indicating a period of time which the user is entitled to connection, when the user who has a contract of a prepaid system for prepaying fees for particular connection time makes connection to the uncontracted company which the user does not have a contract with; and
notifying, by the authentication server of the uncontracted company, the authentication server of the contracted company of remaining units obtained by subtracting the period of the connection time by the user to the uncontracted company, when there is a request from the authentication server of the contracted company.

10. The Internet roaming method of the prepaid system according to claim 9,
wherein connection period of time per unit where a user makes connection to the contracted company, and connection period of time per unit where the user makes connection to the uncontracted company are different from each other.

11. The Internet roaming method of the prepaid system according to claim 9,
wherein connection period of time per unit is different in each uncontracted company.
